(19) United States
(12) Patent Application Publication
(10) Pub. No.: US 2018/0174233 A1
(43) Pub. Date: Jun. 21, 2018

(54) SYSTEM AND METHOD FOR MANAGING A LOAN FOR PURCHASE OF A PRODUCT BY A CONSUMER

(71) Applicant: Mastercard International Incorporated, Purchase, NY (US)

(72) Inventor: Pravin Parekh, Pune (IN)

(73) Assignee: Mastercard International Incorporated, Purchase, NY (US)

(21) Appl. No.: 15/844,308

(22) Filed: Dec. 15, 2017

(30) Foreign Application Priority Data
Dec. 21, 2016 (SG) 10201610722R

(51) Int. Cl. G06Q 40/02

(52) U.S. Cl. CPC G06Q 40/025

(57) ABSTRACT

A system for managing a loan for purchase of a product by a consumer comprises a server communicable with the product. The server has a processor and a memory configured to store computer-readable instructions which are executed upon receipt, by the server, of a notification indicating a breach by the consumer of at least one of a set of rules governing the loan. When the instructions are executed, the processor (i) obtains consumer-specific data associated with the consumer; (ii) based on the consumer-specific data, determines an action to be taken in response to the breach; and (iii) communicates, to the product, a control message indicative of the determined action to be taken. The determined action to be taken comprises inhibiting continued working of the product by the consumer for a length of time. The control message is configured to affect the product to perform the action.

### CROSS-REFERENCE TO RELATED APPLICATIONS

This application claims the priority benefit of Singapore Application Serial No. 10201610722R, filed Dec. 21, 2016, which is incorporated herein by reference in its entirety.

### FIELD OF THE INVENTION

The present invention relates to a system and method for managing a loan, in particular, a loan for purchase of a product by a consumer.

### BACKGROUND OF THE INVENTION

Very often, financial institutions are required to spend a substantial amount of time and resources in managing consumers who fail to timely pay their loan installments or default on their loans. Typical methods of handling such consumers include initiating a legal process or confiscating the products (e.g. the car or the home) on which the loans were taken or both. Such methods often lead to legal hassles. Moreover, manpower is needed to confiscate the products and space is required to store such products. There is thus a need for an improved system and method for managing loans.

### SUMMARY OF THE INVENTION

A first aspect of the present invention is a system for managing a loan for purchase of a product by a consumer, the system comprising a server communicable with the product, the server having a processor and a memory configured to store computer-readable instructions, wherein the instructions are executed upon receipt, by the server, of a notification indicating a breach by the consumer of at least one of a set of rules governing the loan and wherein when the instructions are executed, the processor performs the following steps: (i) obtain consumer-specific data associated with the consumer; (ii) based on the consumer-specific data, determine an action to be taken in response to the breach; and (iii) communicate, to the product, a control message indicative of the determined action to be taken; wherein the determined action to be taken comprises inhibiting continued working of the product by the consumer for a length of time and the control message is configured to affect the product to perform said determined action.

A second aspect of the present invention is a computerized method implemented on a server for managing a loan for purchase of a product by a consumer, wherein the server is communicable with the product and the method comprises: (i) receiving, by the server, a notification indicating a breach by the consumer of at least one of a set of rules governing the loan; (ii) obtaining, at the server, consumer-specific data associated with the consumer; (iii) determining, at the server, an action to be taken in response to the breach based on the consumer-specific data; and (iv) communicating, from the server to the product, a control message indicative of the determined action to be taken; wherein the determined action to be taken comprises inhibiting continued working of the product by the consumer for a length of time and the control message is configured to affect the product to perform said determined action.

### BRIEF DESCRIPTION OF THE FIGURES

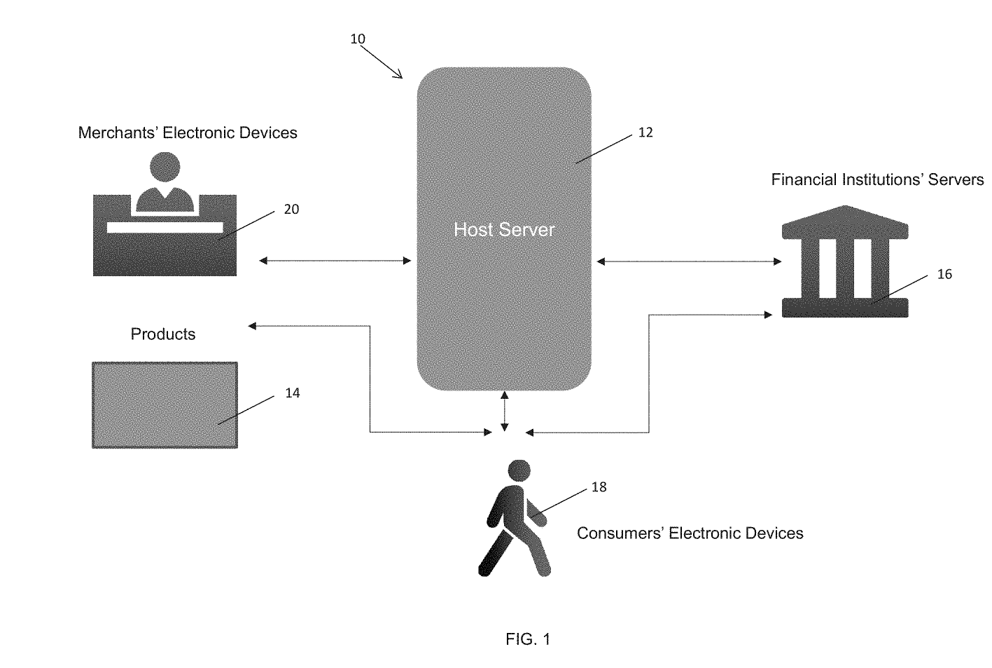

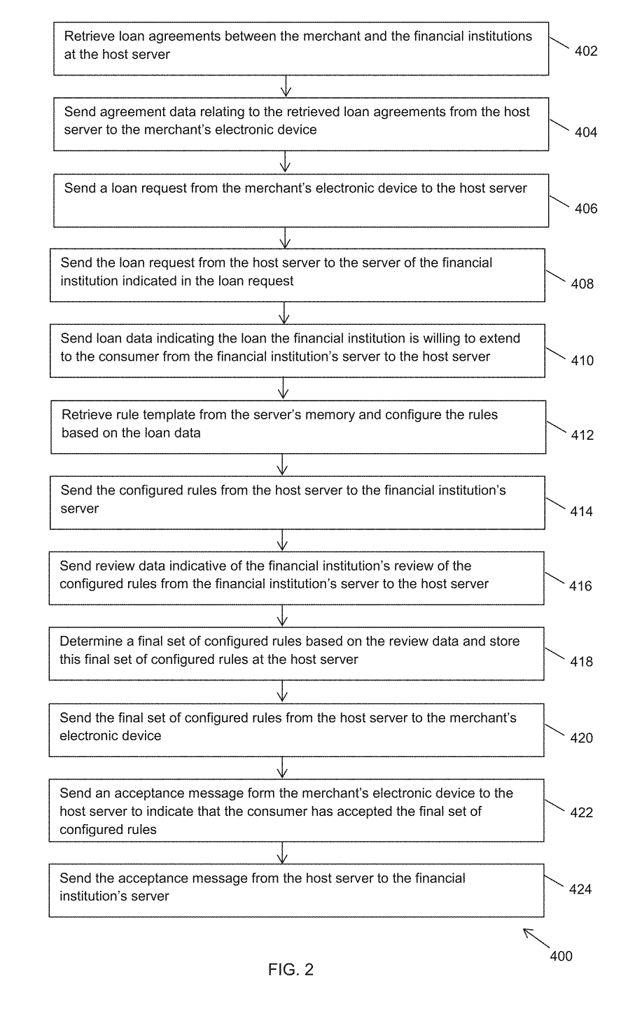

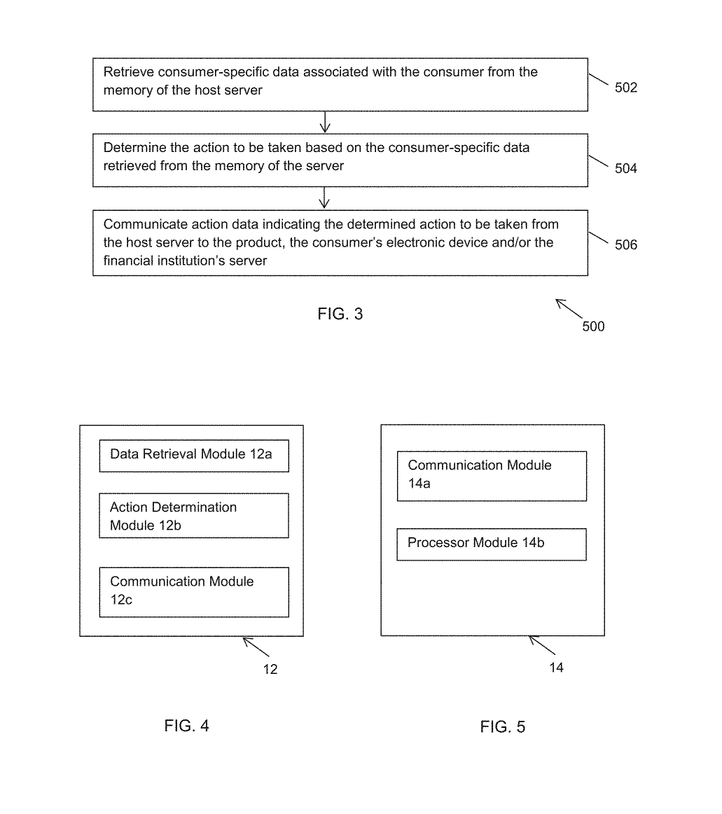

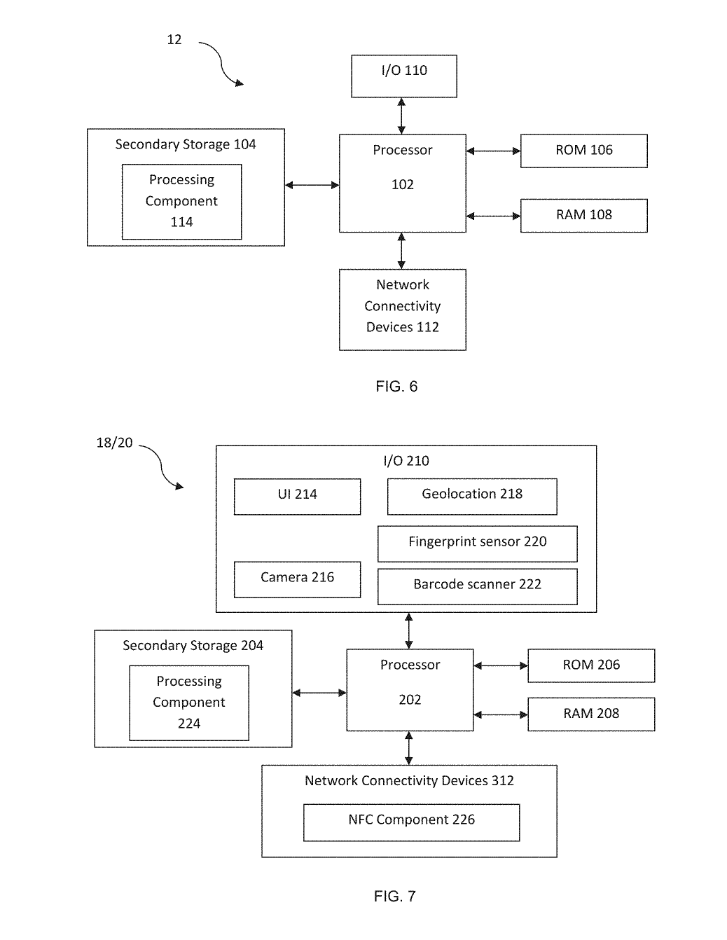

An embodiment of the invention will now be illustrated for the sake of example only with reference to the following drawings, in which:
i) FIG. 1 is an illustration of a system for managing a loan for purchase of a product by a consumer according to an embodiment of the present invention;
ii) FIG. 2 is a flow diagram of a method for processing a loan application implemented at a server of the system of FIG. 1;
iii) FIG. 3 is a flow diagram of a method for managing the loan implemented at the server of the system of FIG. 1;
iv) FIG. 4 is a diagram of various modules or components of the server according to an embodiment of the present invention;
v) FIG. 5 is a diagram of various modules or components of the product according to an embodiment of the present invention;
vi) FIG. 6 is a block diagram illustration of the technical architecture of the server according to an embodiment of the present invention; and
vii) FIG. 7 is a block diagram illustration of the technical architecture of a merchant's electronic device or a consumer's electronic device according to an embodiment of the present invention.

### DETAILED DESCRIPTION

### Overview

The present invention relates to a system for managing a loan for purchase of a product by a consumer. When a server of the system receives a notification that the consumer has breached rules governing the loan, the server takes over control of the product and inhibits or prevents the consumer from continued working or use of the product.

A user interface, such as web portal or an application, exposing functionalities of the server is accessed by a merchant selling the product. The merchant registers a profile or account via the user interface, including selection and configuration of rules for managing loans that a consumer may take for purchasing the product from the merchant. Another user interface, such as web portal or an application, exposing functionalities of the server is accessed by a loan provider. The loan provider, e.g. a financial institution, registers a profile or account via the user interface, including selection and configuration of rules for managing loans (from the loan provider) that a consumer may take for purchasing the product from the merchant.

In one embodiment, a consumer approaches the merchant and wants to purchase the product. The merchant application sends an initiate request to the server. The initiate request includes the merchant's identity which is used by the server to retrieve loan agreements between the merchant and the loan providers/financial institutions stored in the server. Agreement data relating to the retrieved loan agreements is sent from the server to the merchant application. For each retrieved loan agreement, the agreement data may include the identity of the financial institution, and terms of the loan agreement. The merchant or consumer or both can review this agreement data to decide whether to take up a loan and if so, which financial institution to request the loan from. A loan request is sent from the merchant application to the server. This loan request includes the consumer's details, the identity of the financial institution to request the loan from, and the identity of the product the consumer wishes to purchase. The loan request is sent from the server to the financial institution indicated in the loan request. Loan data indicating the loan the financial institution is willing to extend to the consumer is sent from the financial institution indicated in the loan request to the server. The loan data includes the consumer's profile, the identity of the product the consumer wishes to purchase, and general terms of the loan the financial institution is willing to extend to the consumer. A set of configured rules governing the loan is obtained from the server. The rules may be configured to be customized to each consumer and the product. The configured rules may indicate when to inhibit continued working or use of the product by the consumer and how long this inhibition should last.

The set of configured rules is sent from the server to the financial institutions. The financial institutions review this set of configured rules and decides if they agree with the rules. The merchant may negotiate loan agreements with the financial institutions that agree with the rules. Review data indicative of the financial institution's review of the set of configured rules is received by the server. This review data may include amended configured rules or amendments to be made to the rules (if the financial institution does not agree with the configured rules it received). Alternatively, the review data may include a message approving the configured rules. Based on the review data, a final set of configured rules is determined by the server and is stored together with the consumer's identity in the server. The final set of configured rules is sent from the server to the merchant application. The merchant or the consumer or both can review this final set of configured rules and decide whether to proceed with the loan. An acceptance message is sent from the merchant application to the server to indicate that the consumer has accepted the final set of configured rules. The acceptance message is sent from the server to the financial institution. Upon receiving the acceptance message, the financial institution performs the necessary steps to start the loan to the consumer.

A notification indicating whether the pre-agreed installment is timely paid by the consumer to the financial institution is sent every predetermined period of time from the financial institution to the server. When the consumer defaults on the loan or misses an installment payment, a notification indicating the failure to pay the installment is sent to the server from the financial institution. Consumer-specific data is obtained or retrieved by the server. This data includes one or more of (a) the final set of configured rules governing the consumer's loan associated with purchase of the product 14, (b) the number of times the consumer has failed to pay the pre-agreed installment, (c) the dates the consumer failed to pay the pre-agreed installment.

Based on the consumer-specific data, the server determines the action to be taken. Action data indicating the determined action to be taken is communicated in the form of a control message from the server to at least one of the product which the consumer has purchased under the loan, an electronic device of the consumer, and the financial institution. The action to be taken is to inhibit continued working or use of the product by the consumer for a length of time (e.g. a few hours, a few days or until the consumer has paid all the outstanding installments) as determined based on the rules stating how long the inhibition should last.

With the above system, the action to be taken can be determined by the server, based on the consumer-specific data obtained by the server. This can be done without any manual intervention. This helps to reduce the amount of effort required to determine the action to be taken. Further, the above system achieves the inhibition of the continued working or use of the product by the consumer via the control message, thus eliminating the need for manual intervention to seize the product from the consumer. This helps to decrease the manpower needed to manage the loan. It also increases the speed of responding to a breach in a rule governing the loan. These in turn reduce the costs for the institution extending the loan.

### DESCRIPTION OF EMBODIMENTS

As used herein, purchase of a product can mean buying the product for permanent (or at least long term) ownership of the product. Purchase may also be referred to as a temporary purchase, such as renting or leasing the product. The product may include utility services such as power supply, water supply, internet services etc. In this regard, payment for the purchase of the services is in the form of periodic fees, e.g. subscriptions. The product may also include Internet-of-Things (IOT) enabled devices such as IOT enabled vehicles, IOT enabled electricity meters, IOT enabled homes (i.e. smart homes) and IOT enabled electrical appliances (e.g. refrigerators or televisions).

FIG. 1 shows a system 10 for managing a loan for purchase of a product 14 by a consumer according to an embodiment of the present invention.

The system 10 includes a host server in the form of a server 12 having a processor and a memory configured to store computer-readable instructions. The memory is further configured to store loan agreements between various merchants and financial institutions. The memory is also configured to store a rule template including a plurality of configurable rules for governing the loans.

The server 12 is communicable with one or more products 14 sold by the merchants. Each product 14 is configured to be affected by one or more control messages. At least one of the control messages causes inhibition of the continued working or use of the product 14 by the consumer (by for example, disabling a switch or an engine) and at least one of the control messages causes allowance of the continued working or use of the product 14 by the consumer after a previous inhibition (by for example, enabling the switch or the engine).

The control messages may include digital or instruction or function codes recognizable by the product 14 as instructions to perform particular actions to affect the product 14. Some examples of the digital codes, together with what the instructions associated with them are, are provided below:
Code 1001—disable a function of the product 14 for one hour;
Code 1002—disable the function of the product 14 for two hours;
Code 1003—disable the function of the product 14 for three hours;
Code 1024—disable the function of the product 14 for one day;
Code 1048—disable the function of the product 14 for two days;
Code NNNN—disable the function of the product 14 until a pre-agreed installment the consumer owes is paid by the consumer.

The server 12 is also configured to communicate with the financial institutions' servers 16, the consumers' electronic devices 18 and the merchants' electronic devices 20. The consumers' and merchants' electronic devices 18, 20 may include one or more of mobile phones, smartphones, personal digital assistants (PDAs), tablets, laptops and computers.

To apply for a loan for purchase of a product 14 from a merchant, an initiate request is first sent from the merchant's electronic device 20 to the server 12. The initiate request includes the merchant's identity. The merchant's identity may be included in the initiate request in the form of identification data such as name of the merchant or media access control (MAC) address of the merchant's electronic device 20 or both.

Upon receipt of the initiate request from a merchant's electronic device 20, computer readable instructions stored on the memory of the server 12 are executed to implement, on the server 12, a method 400 for processing the loan application, the steps of which are shown in FIG. 2. This computer-implemented method 400 includes steps 402-424 which are elaborated below.

In step 402, using the merchant's identity included in the initiate request, the loan agreements between the merchant and the financial institutions stored in the memory of the server 12 are retrieved.

In step 404, agreement data relating to the retrieved loan agreements is sent from the server 12 to the merchant's electronic device 20. For each retrieved loan agreement, the agreement data may include the identity of the financial institution, and one or more terms of the loan agreement. The merchant or the consumer or both can review this agreement data to decide whether to take up a loan and if so, which financial institution to request the loan from.

In step 406, a loan request is sent from the merchant's electronic device 20 to the server 12. In one embodiment, this loan request includes the consumer's details (such as the consumer's name and an identity number of the consumer), the identity of the financial institution to request the loan from, and the identity of the product 14 the consumer wishes to purchase. The identity of the product 14 is a stock keeping unit (SKU) data and may be in the form of an identification number or code (e.g. barcode) that uniquely identifies the product 14 from other products.

In step 408, the loan request is sent from the server 12 to the server 16 of the financial institution indicated in the loan request.

In step 410, loan data indicating the loan the financial institution is willing to extend to the consumer is sent from the server 16 of the financial institution indicated in the loan request to the server 12. In one embodiment, the loan data includes the consumer's profile, the identity of the product 14 the consumer wishes to purchase (similar to that in the loan request), and general terms of the loan the financial institution is willing to extend to the consumer. The consumer's profile may include not only consumer's details similar to those in the loan request but also information such as the consumer's credit score, the consumer's outstanding payments or the consumer's demographic details. The consumer's credit score may be based on the consumer's credit history which may be obtained by the financial institution's server 16 from for example, an external database. The general terms of the loan may include a loan amount and an installment to be paid by the consumer every predetermined period of time (e.g. an equated monthly installment (EMI)).

In step 412, the rule template is retrieved from the memory of the server 12 and the configurable rules of the rule template are configured by the processor, based on the loan data received by the server 12 in step 410. A set of configured rules governing the loan is thus obtained. The rules may be configured to be customized to each consumer and the product 14. In particular, the configurable rules may be configured based on one or more of (a) the loan amount, (b) the identity of the product 14, (c) the credit score of the consumer and (d) outstanding payments of the consumer. The configured rules may indicate when to inhibit continued working or use of the product 14 by the consumer and how long this inhibition should last. In particular, the configured rules may state harsher actions for users with poorer credit score. The configured rules may also indicate an installment to be paid by the consumer every predetermined period of time. Based on the identity of the product 14, the configured rules may be stricter for products 14 with higher value or that are more expensive, so as to deter consumers from defaulting on the loan.

The following describes examples of configured rules obtained in step 412.

For consumers with a credit score in the range of 90 to 99 (i.e. excellent credit score consumers) but who have outstanding payments of between $100 to $500,

Upon the first EMI the consumer fails to pay, send a polite reminder to the consumer;

Upon the second EMI the consumer fails to pay, send a polite reminder to the consumer;

Upon the third EMI the consumer fails to pay, send a polite reminder to the consumer and notify the consumer of the consequences if the consumer does not pay the EMIs that he or she has owed so far;

Upon the fourth EMI the consumer fails to pay, send a control message to the product 14 to digitally act on the product 14 to inhibit continued working or use of the product 14 by the consumer, with such inhibition lasting for a few days;

Upon the fifth EMI the consumer fails to pay, send a control message to the product 14 to digitally act on the product 14 to inhibit continued working or use of the product 14 by the consumer, with such inhibition lasting until the consumer has paid all the outstanding EMIs.

For consumers with a credit score in the range of 90 to 99 (i.e. excellent credit score consumers) but who have outstanding payments of between $5000 to $10000,

Upon the first EMI the consumer fails to pay, send a polite reminder to the consumer;

Upon the second EMI the consumer fails to pay, send a polite reminder to the consumer;

Upon the third EMI the consumer fails to pay, send a polite reminder to the consumer and notify the consumer of the consequences if the consumer does not pay the EMIs that he or she has owed so far;

Upon the fourth EMI the consumer fails to pay, send a control message to the product 14 to digitally act on the product 14 to inhibit continued working or use of the product 14 by the consumer, with such inhibition lasting until the consumer has paid all the outstanding EMIs.

For consumers with a credit score in the range of 90 to 99 (i.e. excellent credit score consumers) but who have outstanding payments of between $15000 to $25000,

Upon the first EMI the consumer fails to pay, send a polite reminder to the consumer;

Upon the second EMI the consumer fails to pay, send a polite reminder to the consumer and notify the consumer of the consequences if the consumer does not pay the EMIs that he or she has owed so far;

Upon the third EMI the consumer fails to pay, send a control message to the product 14 to digitally act on the product 14 to inhibit continued working or use of the product 14 by the consumer, with such inhibition lasting until the consumer has paid all the outstanding EMIs.

For consumers with a credit score in the range of 80 to 89 (i.e. very good credit score consumers) but who have outstanding payments of between $100 to $500,

Upon the first EMI the consumer fails to pay, send a polite reminder to the consumer;

Upon the second EMI the consumer fails to pay, send a polite reminder to the consumer and notify the consumer of the consequences if the consumer does not pay the EMIs that he or she has owed so far;

Upon the third EMI the consumer fails to pay, send a control message to the product 14 to digitally act on the product 14 to inhibit continued working or use of the product 14 by the consumer, with such inhibition lasting until the consumer has paid all the outstanding EMIs.

For consumers with a credit score in the range of 10 to 19 (i.e. bad credit score consumers) but who have outstanding payments of between $100 to $500,

Upon the first EMI the consumer fails to pay, send a polite reminder to the consumer and notify the consumer of the consequences if the consumer does not pay the EMIs that he or she has owed so far;

Upon the second EMI the consumer fails to pay, send a control message to the product 14 to digitally act on the product 14 to inhibit continued working or use of the product 14 by the consumer, with such inhibition lasting until the consumer has paid all the outstanding EMIs.

For consumers with a credit score in the range of 10 to 19 (i.e. bad credit score consumers) but who have outstanding payments of between $10000 to $15000,

Upon the first EMI the consumer fails to pay, send a polite reminder to the consumer and notify the consumer of the consequences if the consumer does not pay the EMIs that he or she has owed so far;

Upon the second EMI the consumer fails to pay, send a control message to the product 14 to digitally act on the product 14 to inhibit continued working or use of the product 14 by the consumer, with such inhibition lasting until the consumer has paid all the outstanding EMIs;

Upon the third EMI the consumer fails to pay, send a message to the server 16 of the financial institution to liquidate the collaterals the consumer has put up for the loan;

Upon the fourth EMI the consumer fails to pay, send a message to the server 16 of the financial institution to mark the product 14 for auction.

In step 414, the set of configured rules is sent from the server 12 to the server 16 of the financial institution. Particularly, the set of configured rules governs the loan that is provided by the financial institution to the consumer. The financial institution reviews this set of configured rules and decides if it agrees with the rules. In another embodiment, the set of configured rules is sent from the server 12 to the multiple servers 16 of the financial institutions. Merchants may negotiate loan agreements with the financial institutions that agree with the rules.

In step 416, review data indicative of the financial institution's review of the set of configured rules is received by the server 12 from the server 16 of the financial institution. This review data may include amended configured rules or amendments to be made to the rules (if the financial institution does not agree with the configured rules it received). Alternatively, the review data may include a message approving the configured rules. In some situations, the financial institution may wish to extend a special loan rate to particular consumers. Step 416 of method 400 takes into account such situations by allowing the financial institution to review and propose amendments to the configured rules.

In step 418, based on the review data, a final set of configured rules is determined by the server 12 and is stored together with the consumer's identity in the memory of the server 12. The consumer's identity may be in the form of a government-issued identification number.

In step 420, the final set of configured rules is sent from the server 12 to the merchant's electronic device 20. The merchant or the consumer or both can review this final set of configured rules and decide whether to proceed with the loan.

In step 422, an acceptance message is sent from the merchant's electronic device 20 to the server 12 to indicate that the consumer has accepted the final set of configured rules. This acceptance message may include the consumer's signature.

In step 424, the acceptance message is sent from the server 12 to the server 16 of the financial institution.

Upon receiving the acceptance message on its server 16, the financial institution performs the necessary steps to start the loan to the consumer. A notification indicating whether the pre-agreed installment is timely paid by the consumer to the financial institution is sent every predetermined period of time (e.g. each month) from the server 16 of the financial institution to the server 12.

Upon receipt of a notification indicating a failure by the consumer in paying the pre-agreed installment, further computer readable instructions stored on the memory of the server 12 are executed to implement, on the server 12, a method 500 for managing the loan for purchase of the product 14 by the consumer, the steps of which are shown in FIG. 3 and FIG. 4. This computer-implemented method 500 includes steps 502-506 which are elaborated below.

In step 502, consumer-specific data associated with the consumer is obtained or retrieved, by a data retrieval module or component 12a of the server 12, from the memory of the server 12. The step 502 is triggered upon receipt of the notification indicating failure by the consumer in paying the pre-agreed installment. The consumer-specific data is identified by the server 12 based on the consumer's identity, e.g. government-issued identification number. This data may include one or more of (a) the final set of configured rules governing the consumer's loan associated with purchase of the product 14, (b) the number of times the consumer has failed to pay the pre-agreed installment, (c) the dates the consumer failed to pay the pre-agreed installment. The data may also include other details of every installment the consumer failed to pay.

In step 504, based on the consumer-specific data retrieved from the memory of the server 12, an action determination module or component 12b of the server 12 determines the action to be taken.

In step 506, action data indicating the determined action to be taken is communicated, by a communication module or component 12c of the server 12, in the form of a control message from the server 12 to at least one of the product 14 which the consumer has purchased under the loan, the consumer's electronic device 18, and the server 16 of the financial institution.

The determined action to be taken may be to send a reminder to the consumer and in this case, the action data may include an SMS notification communicated to the consumer's electronic device 18.

Alternatively, the action to be taken may be to inhibit continued working or use of the product 14 by the consumer for a length of time (e.g. a few hours, a few days or until the consumer has paid all the outstanding installments) as determined based on the rules stating how long the inhibition should last. For example, the product 14 may be a car and the determined action to be taken may be to lock the car or lock the fuel tank or both for one week. In another example, the product 14 may be a refrigerator and the determined action to be taken may be to cut the power supply to the refrigerator for a month. In this case, the action data may include a control message. This control message is indicative of the determined action to be taken and is communicated to the product 14 to affect the product 14 to perform the determined action (i.e. inhibit continued use of the product 14). In one embodiment, the product 14 includes utility services controlled by a utility organization. The control message is communicated from the server 12 to the utility organization to disable utility services to the consumer. In another embodiment, the product 14 is an IOT enabled device with an electronic communications module for receiving the control message from the server 12.

With reference to FIG. 5, the control message may include a digital code recognizable by the product 14 as an instruction to affect the product 14 to perform the action. More particularly, the digital code is receivable by a communications module or component 14a of the product 14. The digital code is processed and the instructions from the digital code processed by a processor module or component 14b of the product 14. Besides inhibiting continued use of the product 14, the action may further include notifying the consumer and the financial institution about the inhibition. In this case, besides the control message, the action data may further include SMS notifications sent to the consumer's electronic device 18 and messages sent to the server 16 of the financial institution.

Yet alternatively, the determined action may include liquidating the collaterals put up by the consumer for the loan or marking the product 14 as an asset for auction to recover the loan (this is usually after the continued working or use of the product 14 has been inhibited and the consumer continues to not pay the installment) or both. In this case, the action data may include notifications to the server 16 of the financial institution to inform the financial institution to liquidate the collaterals or to mark the product 14 as an asset for auction.

If continued working or use of the product 14 is to be inhibited until the consumer pays all the installments, then, upon receipt, by the server 12, of a notification indicating that such payment has been performed, yet further computer readable instructions stored on the memory of the server 12 are executed to implement, on the server 12, the following steps. Further, consumer-specific data associated with the consumer is retrieved from the memory of the server 12. A further action to be taken is determined based on the further consumer-specific data and a further control message indicative of the further action is communicated from the server 12 to the product 14. The further action may include allowing continued working or use of the product 14 by the consumer and in this case, the further control message is configured to affect the product 14 to perform the further action. Similarly, this control message may include a digital code that the product 14 recognizes as an instruction to allow continued working or use of the product 14.

In a specific example, the product 14 includes a connected car and the loan is a car loan the consumer wishes to obtain from a financial institution. The merchant initiates the method 400 by sending an initiate request from his or her electronic device 20 to the server 12. Steps 402 to 424 are then performed. As mentioned above, the loan request received by the server 12 from the merchant's electronic device 20 in step 406 includes the consumer's details, the identity of the product 14 and the financial institution to request the loan from. In this specific example, the identity of the product 14 includes the type of car and two digital codes recognizable by the product 14—one to lock the car and the other to unlock the car. Further, in step 412 of this specific example, the configuration of the rules is performed based on the car type, the loan amount, EMI and the consumer credit score. For instance, if the car type is “XYZ”, the loan amount is $10,000, EMI is $800 and the consumer's credit score is 300, the configured rules may include sending a polite reminder if the consumer fails to pay the EMI in any of the first 3 months. Alternatively, the configured rules may include sending a polite reminder the first time the consumer fails to pay the EMI, sending a further reminder and notifying the consumer of the consequences of not paying the EMI the second time the consumer fails to pay the EMI, and sending a control message to the car to digitally lock the car with one of the digital codes the third time the consumer fails to pay the EMI. In this case, only after the consumer has successfully paid all the overdue EMIs, the server 12 sends a control message to the car to digitally unlock the car with the other of the digital codes.

Commercially, a web portal or software application or mobile app (collectively referred to as “application”) can be provided to financial institutions and merchants to make use of services and functions offered by the server 12. In one embodiment, the application is used to configure the set of rules for customization, e.g. of the loan agreement. The configuration of the rules may be performed by modifying or varying the rules based on business or commercial factors affecting the merchants or financial institutions.

FIG. 6 illustrates a block diagram showing a technical architecture of the server 12. The technical architecture includes a processor 102 (which may be referred to as a central processor unit or CPU) that is in communication with memory devices including secondary storage 104 (such as disk drives or memory cards), read only memory (ROM) 106, and random access memory (RAM) 108. The processor 102 may be implemented as one or more CPU chips. The technical architecture further includes input/output (I/O) devices 110, and network connectivity devices 112.

The secondary storage 104 is typically included of a memory card or other storage device and is used for non-volatile storage of data and as an over-flow data storage device if RAM 108 is not large enough to hold all working data. Secondary storage 104 may be used to store programs which are loaded into RAM 108 when such programs are selected for execution.

The secondary storage 104 has a processing component 114, including non-transitory instructions operative by the processor 102 to perform various operations of the method 400/500 according to various embodiments of the present disclosure. The ROM 106 is used to store instructions and perhaps data which are read during program execution. At least one of the secondary storage 104, ROM 106, and RAM 108 may be referred to in some contexts as computer-readable storage media or non-transitory computer-readable media. Non-transitory computer-readable media include all computer-readable media, with the sole exception being a transitory propagating signal per se.

The I/O devices 110 may include printers, video monitors, liquid crystal displays (LCDs), plasma displays, touch screen displays, keyboards, keypads, switches, dials, mice, track balls, voice recognizers, card readers, paper tape readers, or other known input devices.

The network connectivity devices 112 may take the form of modems, modem banks, Ethernet cards, universal serial bus (USB) interface cards, serial interfaces, token ring cards, fibre distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), or other air interface protocol radio transceiver cards, and other well-known network devices. These network connectivity devices 112 may enable the processor 102 to communicate with the Internet or one or more intranets. With such a network connection, it is contemplated that the processor 102 might receive information from the network, or might output information to the network in the course of performing the operations or steps of the method 400/500. Such information, which is often represented as a sequence of instructions to be executed using processor 102, may be received from and outputted to the network, for example, in the form of a computer data signal embodied in a carrier wave.

The processor 102 executes instructions, codes, computer programs, scripts which it accesses from hard disk, floppy disk, optical disk (these various disk based systems may all be considered secondary storage 104), flash drive, ROM 106, RAM 108, or the network connectivity devices 112. While only one processor 102 is shown, multiple processors may be present. Thus, while instructions may be discussed as executed by a processor, the instructions may be executed simultaneously, serially, or otherwise executed by one or multiple processors.

It should be appreciated that the technical architecture of the server 12 may be formed by one computer, or multiple computers in communication with each other that collaborate to perform a task. For example, but not by way of limitation, an application may be partitioned in such a way as to permit concurrent or parallel (or both) processing of the instructions of the application. Alternatively, the data processed by the application may be partitioned in such a way as to permit concurrent or parallel (or both) processing of different portions of a data set by the multiple computers. In an embodiment, virtualization software may be employed by the technical architecture to provide the functionality of a number of servers that is not directly bound to the number of computers in the technical architecture. In an embodiment, the functionality disclosed above may be provided by executing the application(s) in a cloud computing environment. Cloud computing may include providing computing services via a network connection using dynamically scalable computing resources. A cloud computing environment may be established by an enterprise or may be hired on an as-needed basis from a third party provider or both.

FIG. 7 illustrates a block diagram showing a technical architecture of the merchant's electronic device 20 or the consumer's electronic device 18 which may be a mobile device such as a mobile phone. The technical architecture includes a processor 202 (which may be referred to as a central processor unit or CPU) that is in communication with memory devices including secondary storage 204 (such as disk drives or memory cards), read only memory (ROM) 206, and random access memory (RAM) 208. The processor 202 may be implemented as one or more CPU chips. The technical architecture further includes input/output (I/O) devices 210, and network connectivity devices 212.

The I/O devices 210 include a user interface (UI) 214 and an image capture device or camera 216. The electronic device 18 or 20 may further include a geolocation module 218. The UI 214 may include a touch screen, keyboard, keypad or other known input devices, e.g. fingerprint sensor 220 and barcode scanner 222. The camera 216 allows the merchant or consumer to capture image data and save the captured image data in electronic form on the electronic device 18 or 20, e.g. on the secondary storage 204. The fingerprint sensor 220 allows the merchant or consumer to read and capture the consumer's fingerprint as authentication data. The geolocation module 218 is operable to determine the geolocation of the mobile device 200 using signals from, for example global positioning system (GPS) satellites. The barcode scanner 222 allows the merchant or consumer to scan barcodes from products to obtain transaction data including the prices of products.

The secondary storage 204 is typically included of a memory card or other storage device and is used for non-volatile storage of data and as an over-flow data storage device if RAM 208 is not large enough to hold all working data. Secondary storage 204 may be used to store programs which are loaded into RAM 208 when such programs are selected for execution.

The secondary storage 204 has a processing component 224, including non-transitory instructions operative by the processor 202 to perform various operations of the method 400/500 according to various embodiments of the present disclosure. The ROM 206 is used to store instructions and perhaps data which are read during program execution. At least one of the secondary storage 204, ROM 206, and RAM 208 may be referred to in some contexts as computer-readable storage media or non-transitory computer-readable media. Non-transitory computer-readable media include all computer-readable media, with the sole exception being a transitory propagating signal per se.

The network connectivity devices 212 may take the form of modems, modem banks, Ethernet cards, universal serial bus (USB) interface cards, serial interfaces, token ring cards, fibre distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), or other air interface protocol radio transceiver cards, and other well-known network devices. For example, the network connectivity devices 212 include an NFC component 226 of the merchant electronic device 200. These network connectivity devices 212 may enable the processor 202 to communicate with the Internet or one or more intranets. With such a network connection, it is contemplated that the processor 202 might receive information from the network, or might output information to the network in the course of performing the operations or steps of the method 400/500. Such information, which is often represented as a sequence of instructions to be executed using processor 202, may be received from and outputted to the network, for example, in the form of a computer data signal embodied in a carrier wave.

The processor 202 executes instructions, codes, computer programs, scripts which it accesses from hard disk, floppy disk, optical disk (these various disk based systems may all be considered secondary storage 204), flash drive, ROM 206, RAM 208, or the network connectivity devices 212. While only one processor 202 is shown, multiple processors may be present. Thus, while instructions may be discussed as executed by a processor 202, the instructions may be executed simultaneously, serially, or otherwise executed by one or multiple processors 202.

It is understood that by programming or loading executable instructions onto the technical architecture of the server 12, the consumer's electronic device 18 or the merchant's electronic device 20 or both, at least one of the CPU 102/202, the ROM 106/206, and the RAM 108/208 are changed, transforming the technical architecture in part into a specific purpose machine or apparatus having the functionality as taught by various embodiments of the present disclosure. It is fundamental to the electrical engineering and software engineering arts that functionality that can be implemented by loading executable software into a computer can be converted to a hardware implementation by well-known design rules.

Various modifications will be apparent to those skilled in the art.

For example, the initiate request to initiate method 400 need not be sent from the merchant's electronic device 20. It can instead be sent from the consumer's electronic device 18. Similarly, the agreement data can be received by the consumer's electronic device 18 instead of the merchant's electronic device 20.

Further, the system 10 may be configured such that the notification initiating method 500 is a notification indicating a breach by the consumer of a rule governing the loan, whereby this rule does not necessarily have to relate to the payment of the pre-agreed installment. Such a notification may be sent from the financial institution's server 16 or may be sent from another source.

In addition, the configuration of the rules need not be performed on the host server 12. Instead, it can be performed on a separate processor (e.g. the processor of the financial institution's server 16) and then communicated to the host server 12. The configured rules and the rule template also need not be stored at the server 12. Similarly, they may be stored on a separate unit communicable with the server 12 and may be sent to the server 12 only when they are needed.

1. A system for managing a loan for purchase of a product by a consumer, the system comprising a server communicable with the product, the server having a processor and a memory configured to store computer-readable instructions,
wherein the instructions are executed upon receipt, by the server, of a notification indicating a breach by the consumer of at least one of a set of rules governing the loan and wherein when the instructions are executed, the processor performs the following steps:
(i) obtain consumer-specific data associated with the consumer;
(ii) based on the consumer-specific data, determine an action to be taken in response to the breach; and
(iii) communicate, to the product, a control message indicative of the determined action to be taken;
wherein the determined action to be taken comprises inhibiting continued working of the product by the consumer for a length of time and the control message is configured to affect the product to perform said determined action.

2. The system according to claim 1, wherein the memory is further configured to store the consumer-specific data and step (i) comprises retrieving the consumer-specific data from the memory of the server.

3. The system according to claim 1, wherein the consumer-specific data comprises the set of rules governing the loan.

4. The system according to claim 1, wherein the set of rules indicate the length of time of the inhibition of the continued working of the product.

5. The system according to claim 1, wherein the set of rules is configured from a rule template comprising a plurality of configurable rules.

6. The system according to claim 5, wherein the processor is operative to configure the set of rules from the rule template.

7. The system according to claim 1, wherein the set of rules is configured to be customized to the consumer and the product, and wherein the set of rules is configured based on one or more of (a) amount of the loan, (b) an identity of the product, (c) a credit history of the consumer, and (d) outstanding payments of the consumer.

8. The system according to claim 1, wherein the consumer-specific data comprises a number of times the consumer has breached the at least one of the set of rules.

9. The system according to claim 1, wherein the breach of the at least one of the rules comprises a failure by the consumer in paying a pre-agreed installment.

10. The system according to claim 1, wherein the memory is configured to store further computer-readable instructions and wherein said further instructions are executed upon receipt, by the server, of a notification indicating that the consumer no longer breaches the at least one of the set of rules and wherein when the further instructions are executed, the processor performs the following steps:
(i) obtain further consumer-specific data associated with the consumer;
(ii) determine a further action to be taken based on the further consumer-specific data; and
(iii) communicate, to the product, a further control message indicative of the further action to be taken;
wherein the further action to be taken comprises allowing continued working of the product by the consumer and the further control message is configured to affect the product to perform said further action.

11. A computerized method implemented on a server for managing a loan for purchase of a product by a consumer, wherein the server is communicable with the product and the method comprises:
(i) receiving, by the server, a notification indicating a breach by the consumer of at least one of a set of rules governing the loan;
(ii) obtaining, at the server, consumer-specific data associated with the consumer;
(iii) determining, at the server, an action to be taken in response to the breach based on the consumer-specific data; and
(iv) communicating, from the server to the product, a control message indicative of the determined action to be taken;
wherein the determined action to be taken comprises inhibiting continued working of the product by the consumer for a length of time and the control message is configured to affect the product to perform said determined action.

12. The method according to claim 11, wherein step (i) comprises retrieving the consumer-specific data from a memory of the server.

13. The method according to claim 11, wherein the consumer-specific data comprises the set of rules governing the loan.

14. The method according to claim 11, wherein the set of rules indicate the length of time of the inhibition of the continued working of the product.

15. The method according to claim 11, wherein the set of rules is configured from a rule template comprising a plurality of configurable rules.

16. The method according to claim 15, further comprising configuring, at the server, the set of rules from the rule template.

17. The method according to claim 11, wherein the set of rules is configured to be customized to the consumer and the product, and wherein the set of rules is configured based on one or more of (a) amount of the loan, (b) an identity of the product, (c) a credit history of the consumer, and (d) outstanding payments of the consumer.

18. The method according to claim 11, wherein the consumer-specific data comprises a number of times the consumer has breached the at least one of the set of rules.

19. The method according to claim 11, wherein the breach of the at least one of the rules comprises a failure by the consumer in paying a pre-agreed installment.

20. The method according to claim 11, wherein the method further comprises:
(i) receiving, by the server, a notification indicating that the consumer no longer breaches the at least one of the set of rules;
(ii) obtaining, at the server, further consumer-specific data associated with the consumer;
(iii) determining, at the server, a further action to be taken based on the further consumer-specific data; and
(iv) communicating, from the server to the product, a further control message indicative of the further action to be taken;
wherein the further action to be taken comprises allowing continued working of the product by the consumer and the further control message is configured to affect the product to perform said further action.
